(19) United States
(12) Patent Application Publication
(10) Pub. No.: US 2013/0047456 A1
(43) Pub. Date: Feb. 28, 2013

(54) HEAT PUMP LAUNDRY DRYER MACHINE

(71) Applicants: Onder Balioglu, Tuzla/Istanbul (TR); Hüda Sönmez, Tuzla/Istanbul (TR)

(72) Inventors: Onder Balioglu, Tuzla/Istanbul (TR); Hüda Sönmez, Tuzla/Istanbul (TR)

(21) Appl. No.: 13/499,682

(22) PCT Filed: Sep. 29, 2010
(86) PCT No.: PCT/EP2010/064451

§ 371 Date: Mar. 30, 2012

(30) Foreign Application Priority Data
Oct. 1, 2009 (TR) A 2009/07472

(51) Int. Cl. F26B 19/00

(52) U.S. Cl. 34/86

(57) ABSTRACT

The laundry dryer machine (1) of the present invention comprises a drum (2) wherein laundry desired to be dried are placed, a channel (5) with both ends connected to the drum (2), which provides the cycle air to be circulated in a closed cycle, an evaporator (3) disposed on the channel (5) and which provides the removal of the moisture from the cycle air leaving the drum (2) by condensation, a condenser (4) providing the dehumidified cycle air leaving the evaporator (3) to be heated and a compressor (8) that pumps the refrigerant to the condenser (4) and the evaporator (3).

The present invention relates to the heat pump laundry dryer machine which is prevented from overheating.

In heat pump laundry dryer machines, the drying air that removes the moisture of laundry in the drum, leaves the moisture in the evaporator and enters into the drum again after passing over the condenser. In the refrigeration cycle, the refrigerant delivered to the condenser from the compressor with increased pressure and temperature, enters the evaporator by being constricted in the capillary tube and absorbs heat in the evaporator with the aim of removing moisture from the drying air. The process of removing moisture is achieved as a result of the drying air reaching a certain temperature value at the drum outlet and the drying air cycle is completed. The operating temperatures of the cooling system rise continuously as a result of the continuous operation of the cooling system and the cooling system conditioning the same drying air during the circulation of the drying air. In other words, the drying air heated by the condenser is delivered into the drum and the laundry inside the drum is heated by means of this air. The air leaving the drum leaves the moisture contained therein by passing over the evaporator. After a while, the temperature of the drying air coming over the evaporator increases as the laundry inside the drum is heated. The increased drying air temperature also causes the temperature of the evaporator (evaporation temperature) to increase. Increase of the evaporation temperature increases the condensation temperatures due to configuration of the cooling system and the increased condensation temperature increases the evaporation temperature again. This cycle leads to the problem called “overheating” in the situations when not intervened. The drying air circulation temperatures that shift by the overheating effect cause the compressor to operate in an inefficient range and as a result of this the energy consumption of the system increases.

Moreover, after about half hour passes from the operation of the heat pump laundry dryer machine, the last portions of the evaporator fill in with the refrigerant in the vapor phase (having weak heat transfer ability) due to the increased moisture load. The increasing drying air temperatures cause the evaporator to be filled in with more refrigerant in the vapor phase in the course of time. As a result of this, the temperature of the evaporator increases and the moisture removing capacity of the evaporator decreases.

In the state of the art Japanese Patent Application no JP2008237496, the embodiment of a thermal storage means is described for increasing the drying performance in a heat pump washing/drying machine. By means of this embodiment, the heat absorbed from the refrigerant circulation is again delivered to the refrigerant circulation afterwards.

In the state of the art United States patent document no U.S. Pat. No. 5,709,041, the use of phase changing material (PCM) is described for the recovery of heat in a clothes drying machine with condenser. In the washing/drying machine, increasing the drying performance and reducing the drying time is aimed by using PCM.

The aim of the present invention is the realization of a heat pump laundry dryer machine wherein the overheating problem is prevented and the moisture removing efficiency of the evaporator is increased.

The heat pump laundry dryer machine realized in order to attain the aim of the present invention, explicated in the first claim and the respective claims thereof, comprises one or more receptacles filled with PCM which is disposed in the channel situated between the drum outlet and the evaporator.

Some portion of the heat in the hot drying air leaving the drum is stored in the PCM. Thus, the water retention efficiency of the evaporator is provided to be increased by the cooling system operating efficiently and by preventing the overheating problem of the evaporator disposed in the cooling system.

In an embodiment of the present invention, the receptacle is disposed just before the evaporator.

In another embodiment of the present invention, the receptacle is disposed on the walls of the channel, between the drum outlet and the evaporator, to be parallel to the flow direction of the drying air. In another version of this embodiment, the receptacle is in ring form and is disposed inside the channel to be in contact with the channel walls. In this situation, the drying air passes through the center of the receptacle.

In another embodiment of the present invention, the receptacle is in grill form consisting of pipes filled with PCM. In this embodiment, the drying air passes between pipes. Thus, both the flow of the drying air can be controlled and also the heat transfer surface area between the drying air and the PCM is increased.

By means of the present invention, by preventing the problem of overheating on the cooling system, the compressor is provided to operate more efficiently and in parallel to this energy consumption of the system is provided to be decreased. Moreover, water retention efficiency increases by providing to hold more moisture on the evaporator. Besides, increasing the moisture removing efficiency of the evaporator results in decreasing the drying cycle time.

A heat pump laundry dryer machine realized in order to attain the aim of the present invention is illustrated in the attached figures, where:

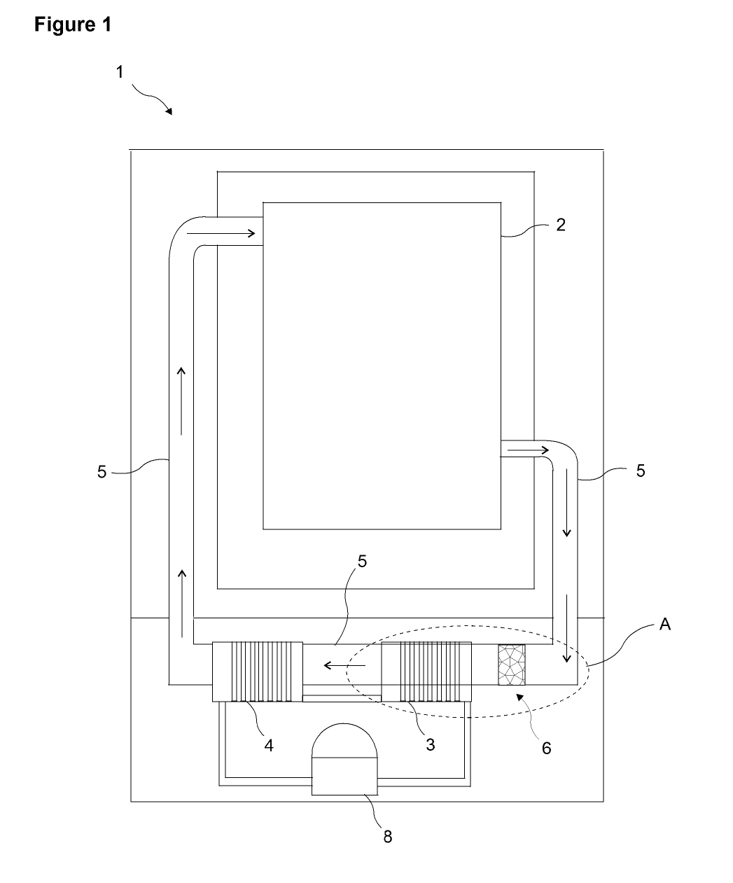

FIG. 1—is the schematic view of a heat pump laundry dryer machine.

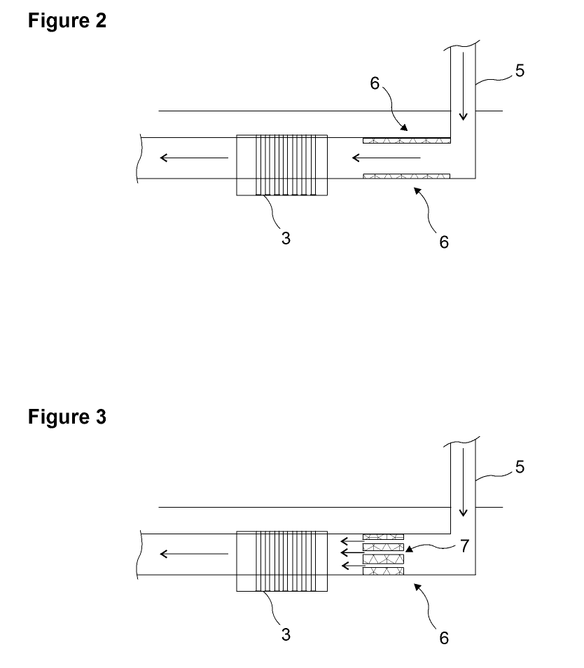

FIG. 2—is the schematic view of detail A in FIG. 1 in an embodiment of the present invention.

FIG. 3—is the schematic view of detail A in FIG. 1 in another embodiment of the present invention.

The elements illustrated in the figures are numbered as follows:
1. Laundry dryer machine
2. Drum
3. Evaporator
4. Condenser
5. Channel
6. Receptacle
7. Passage
8. Compressor

The laundry dryer machine (1) of the present invention comprises a drum (2) wherein laundry desired to be dried are placed, a channel (5) with both ends connected to the drum (2) which provides the cycle air to be circulated in a closed cycle, an evaporator (3) disposed on the channel (5) and which provides to remove the moisture from the cycle air leaving the drum (2) by condensation, a condenser (4) providing to heat the dehumidified cycle air leaving the evaporator (3) and a compressor (8) that pumps the refrigerant to the condenser (4) and the evaporator (3) (FIG. 1).

The laundry dryer machine (1) furthermore comprises one or more receptacles (6) disposed at the portion of the channel (5) remaining between the outlet of the drum (2) and the evaporator (3) wherein the phase changing material (PCM) is contained.

In an embodiment of the present invention, a material that changes phase preferably at a temperature of around 30-50° C. is used as the PCM.

As the laundry dryer machine (1) starts operating, the compressor (8) also operates and the refrigerant is circulated in the cooling cycle. The drying air passes over the evaporator (3) after leaving the drum (2) and while passing over the receptacle (6) situated between the evaporator (3) and the drum (2) outlet, heat transfer is effectuated therebetween the PCM contained in the receptacle (6). At the start, the drying air leaving the drum (2) at low temperature transfers the heat energy contained therein to the PCM in the receptacle (6). Afterwards, the drying air passes over the evaporator (3) and is heated in the condenser (4) to be delivered again into the drum (2) thereby completing a drying air cycle. With the increase of the drying air temperature at the outlet of the drum (2), the amount of energy stored on the PCM also increases. The temperature of the drying air at the drum (2) outlet, having increased during the drying cycle, also increases the temperature of the PCM. The increase of temperature continues until reaching the phase changing temperature of the PCM. When the temperature reaches the phase changing temperature, since the temperature of PCM remains constant throughout phase changing, the drying air remains at the same temperature as the PCM even though the drying air temperature at the drum (2) outlet increases in the course of time. Thus, the phase changing temperature of the PCM and the temperature of the drying air entering the evaporator (3) is equalized. In other words, PCM changes phase and the excess energy contained in the drying air is stored thereon. As a result of the excess energy being stored on the PCM, the temperature of the drying air entering the evaporator (3) is decreased. Accordingly, the condensation temperature is provided to be kept at the desired levels by the evaporation temperature not rising above a certain limit value. As a result of this, the overheating problem is prevented. The energy stored on the PCM throughout the drying cycle is again discharged to the external environment when the drying cycle ends by the effect of the external ambient temperature thus providing the regeneration of the PCM.

In the drying cycle, another effect of using PCM before the evaporator (3), between the drum (2) outlet and the evaporator (3), is the decrease of the time required for heating the laundry in the first period of the drying cycle. At the start of the drying cycle, upon operating the compressor (8) a sudden drop of the evaporation temperatures is observed. As the drying cycle proceeds, the temperature of the drying air passing over the evaporator (3) causes the evaporator (3) to be heated and as a result of this the condensation temperatures also increase. However, the amount of this heating increases at a very low speed at the initial stages of the drying cycle. By means of the PCM application, the relatively colder drying air passing over the evaporator (3) effectuates heat transfer with the PCM and passes over the evaporator (3) relatively hotter and as a result of this, the condensation temperature advances to a hotter point with respect to the initial situation. Accordingly, at the start of the cycle, the temperature of the drying air delivered into the drum (2) for the same time frame increases.

In an embodiment of the present invention, the receptacle (6) is disposed just before the evaporator (3). Thus, the drying air leaving the drum (2) is provided to leave some portion of its heat on the PCM before entering the evaporator (3).

In another embodiment of the present invention, the receptacle (6), containing the PCM therein, is disposed on the walls of the channel (5) situated between the drum (2) outlet and the evaporator (3), in the flow direction of the drying air in the channel (5). The drying air leaving the drum (2) and having the temperature as high as to cause overheating, thermally contacts the receptacle (6) containing PCM therein on the channel (5) wall while passing through the channel (5) and leaves its excess energy on the PCM. In another version of this embodiment of the present invention, the receptacle (6) is disposed all around on the inner peripheries of the channel (5) walls (FIG. 2). In this embodiment, the receptacle (6) is in ring form and is disposed in the channel (5) so as to contact the channel (5) walls from the inside. In this situation, the drying air passes through the center of the receptacle (6).

In another embodiment of the present invention, the receptacle (6) is in grill form consisting of pipes filled with PCM. In this embodiment, the receptacle (6) comprises more than one passage (7) between the pipes, through which the drying air flows. Thus, the flow of the drying air is regulated, furthermore more effective heat transfer is provided to be effectuated between the drying air and the PCM by increasing the heat transfer surface area (FIG. 3).

By means of the present invention, the drying air leaving the drum (2) is provided to be brought to the desired temperature value before entering the evaporator (3).

It is to be understood that the present invention is not limited to the embodiments disclosed above and a person skilled in the art can easily introduce different embodiments. These different embodiments should also be considered within the scope of the claims of the present invention.

1. A laundry dryer machine (1) comprising a drum (2) wherein laundry desired to be dried are placed, a channel (5) with both ends connected to the drum (2) which provides the cycle air to be circulated in a closed cycle, an evaporator (3) disposed on the channel (5) and which provides the removal of the moisture from the cycle air leaving the drum (2) by condensation, a condenser (4) providing the dehumidified cycle air leaving the evaporator (3) to be heated and a compressor (8) that pumps the refrigerant to the condenser (4) and the evaporator (3) and characterized by one or more receptacles (6) disposed at the portion of the channel (5) remaining between the outlet of the drum (2) and the evaporator (3) wherein phase changing material is contained.

2. The laundry dryer machine (1) as in claim 1, wherein the receptacle (6) which is disposed just before the evaporator (3).

3. The laundry dryer machine (1) as in claim 1, wherein the receptacle (6) being disposed on the walls of the channel (5) that is situated between the drum (2) outlet and the evaporator (3) and in the flow direction of the drying air.

4. The laundry dryer machine (1) as in claim 3, wherein the receptacle (6) which is disposed all around on the inner periphery of the channel (5) walls.

5. The laundry dryer machine (1) as in claim 1, wherein the receptacle (6) which is in grill form consisting of pipes filled with phase changing material.

6. The laundry dryer machine (1) as in claim 1 wherein the phase changing material that changes phase at the temperature of 30-50° C.

7. The laundry dryer machine (1) as in claim 2, wherein the receptacle (6) being disposed on the walls of the channel (5) that is situated between the drum (2) outlet and the evaporator (3) and in the flow direction of the drying air.

8. The laundry dryer machine (1) as in claim 7, wherein the receptacle (6) which is disposed all around on the inner periphery of the channel (5) walls.

9. The laundry dryer machine (1) as in claim 2, wherein the receptacle (6) which is in grill form consisting of pipes filled with phase changing material.

10. The laundry dryer machine (1) as in claim 2, wherein the phase changing material that changes phase at the temperature of 30-50° C.

11. The laundry dryer machine (1) as in claim 3, wherein the phase changing material that changes phase at the temperature of 30-50° C.

12. The laundry dryer machine (1) as in claim 4, wherein the phase changing material that changes phase at the temperature of 30-50° C.

13. The laundry dryer machine (1) as in claim 5, wherein the phase changing material that changes phase at the temperature of 30-50° C.

14. The laundry dryer machine (1) as in claim 7, wherein the phase changing material that changes phase at the temperature of 30-50° C.

15. The laundry dryer machine (1) as in claim 8, wherein the phase changing material that changes phase at the temperature of 30-50° C.

16. The laundry dryer machine (1) as in claim 9, wherein the phase changing material that changes phase at the temperature of 30-50° C.
